(19) United States
(12) Patent Application Publication
(10) Pub. No.: US 2011/0109439 A1
(43) Pub. Date: May 12, 2011

(54) INTERPERSONAL COMMUNICATION SYSTEM

(76) Inventor: Paolo Borlenghi, Milano (IT)

(21) Appl. No.: 12/991,583

(22) PCT Filed: May 6, 2009
(86) PCT No.: PCT/IB09/05510

§ 371 Date: Jan. 6, 2011

(30) Foreign Application Priority Data
May 7, 2008 (IT) MI2008A000825

(51) Int. Cl. H04Q 5/22

(52) U.S. Cl. 340/10.1

(57) ABSTRACT

An interpersonal communication system (1) includes a portable personal item (2) (such as an item of clothing, a clothing accessory or a portable device) fitted with a recognition device (3); a server (4); and network communication means (5). The recognition device (3) has a sensor (6) for detecting a physical, physiological or body parameter (e.g. heartbeat) of the person wearing the item (2); a microcontroller (7) connected to the sensor (6) and containing a unique code; and a wireless communication device (8) for transmitting to the server (4), upon the sensor (6) detecting a variation in the parameter, an identification signal identifying the unique code. Upon the server (4) receiving the signal, the network communication means (5) send a message to one or more users selected by the server (4).

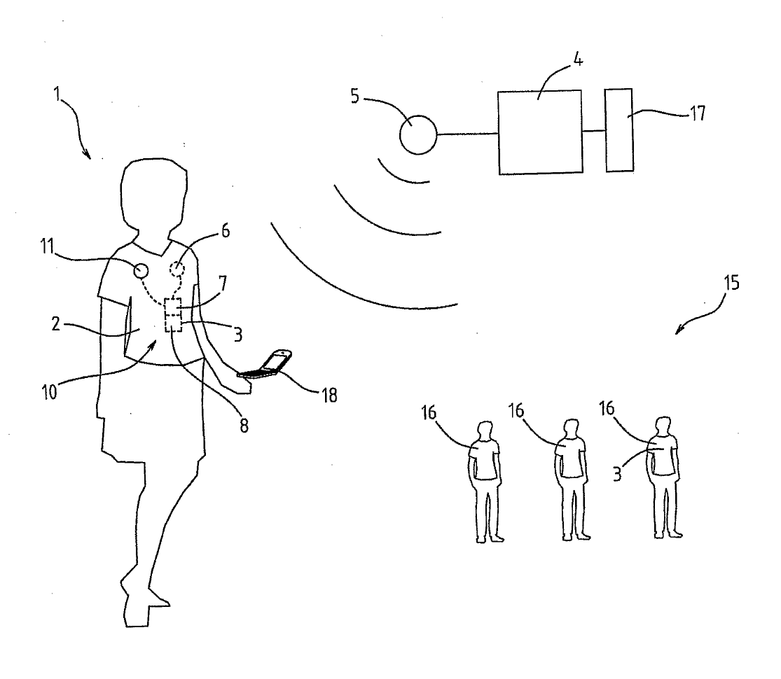

### TECHNICAL FIELD

The present invention relates to an interpersonal communication system, in particular for establishing interpersonal relationships between acquaintances.

### BACKGROUND ART

The difficulty in establishing an interpersonal relationship, i.e. “breaking the ice”, with an acquaintance encountered occasionally is well known.

On the basis of a first encounter, that normally only yields a general impression and basic information about the other person, people are often reluctant to exchange addresses or telephone numbers, even though they may be interested in getting to know the other person better, either because they wish to maintain a certain degree of anonymity and privacy, or need reassurance as to the dependability of the person they, are dealing with.

### DISCLOSURE OF INVENTION

It is an object of the present invention to provide an interpersonal communication system for establishing interpersonal relationships between acquaintances, by helping to “break the ice” and get to know the other person better, while still safeguarding the user's privacy, if necessary.

It is a further object of the invention to provide an interpersonal communication system featuring additional functions, e.g. that can be activated in case of danger or need.

The present invention relates to an interpersonal communication system as defined substantially in the accompanying claim 1 and, as regards additional features, in the dependent Claims.

There is therefore provided an interpersonal communication system which, on the one hand, brings people together by facilitating a first encounter between strangers, and, on the other, initiates interpersonal relay communication, activated at the outset by an emotion-arousing real in-person encounter, while continuing to maintain the anonymity of the parties involved, if necessary. If the parties involved do not wish to remain anonymous, they are nevertheless assured of only coming into contact with other registered users.

The communication process in fact is initiated by a variation in physical parameters detected on the user's person, thus providing a convenient way of “breaking the ice” with chance acquaintances.

There is therefore provided a safe, effective way of establishing interpersonal relationships, while ensuring the anonymity of the parties involved, if necessary.

The same system may also be used for various, e.g. commercial or promotional, purposes, and in case of danger or need.

### BRIEF DESCRIPTION OF THE DRAWING

A non-limiting embodiment of the invention will be described by way of example with reference to the attached drawing, which shows, schematically, an interpersonal communication system in accordance with the invention.

### BEST MODE FOR CARRYING OUT THE INVENTION

With reference to the attached drawing, an interpersonal communication system 1 comprises a portable personal item 2 featuring a recognition device 3; a server 4; and network communication means 5 for sending a message to one or more users selected by server 4.

In the non-limiting example shown, item 2 is an item of clothing, in particular a T-shirt, but may be any other sort of clothing, a clothing accessory, a portable device, any other personal item worn in contact with the skin (a bracelet, watch, jewelry, etc.), or even part of a complex device, such as a car, a vehicle, etc., that is normally used in contact with the user's skin (e.g. a car steering wheel, a bicycle or motorcycle handlebar, etc.). Item 2 is preferably at least partly worn in contact with the skin.

Recognition device 3 comprises at least one sensor 6 for detecting a physical, physiological, or body parameter of the wearer of item 2; a microcontroller 7 connected to sensor 6 and containing a unique code; and a wireless communication device 8 for transmitting an identification signal, identifying the unique code, directly and/or by network communication means 5 to server 4, following a parameter change detected by sensor 6.

More specifically, recognition device 3 comprises one or more sensors 6 for detecting one or more parameters, such as heartbeat, body temperature, perspiration, etc. For the sake of simplicity, the drawing only shows one sensor 6, e.g. for detecting heartbeat, to which reference is made herein purely by way of example, it being understood that item 2 may comprise a number of sensors variously arranged and/or for detecting various parameters.

If necessary for it to function properly, sensor 6 is fitted to item 2 in such a way as to be in contact with the skin of the wearer of item 2.

Microcontroller 7 and wireless communication device are integrated, for example, in a radiofrequency identification RFID chip 10 associated with sensor 6 and communicating with server 4.

The unique code associated with recognition device 3 is assigned to, and identifies the owner of, item 2. The unique code corresponds to information relating to the owner of item 2, and/or to a relay communication address, e.g. an e-mail box, an internet community personal page, a telephone number, etc. Server 4 is provided with this information when the user registers (e.g. when or after purchasing item 2). The unique code may even be, for example, an e-mail address or e-mail address code.

Item 2 optionally also comprises signalling means 11, e.g. vibratory, acoustic, or visual, connected to sensor 6, e.g. by microcontroller 7, to emit a warning signal following a variation in the parameter detected by sensor 6.

System 1 comprises a wireless sensor network (WSN) 15 comprising a number of distributed nodes 16 defined by respective recognition devices 3 fitted to items 2 (not necessarily all of the same type) and connected to server 4; and a database 17 of registered users, e.g. owners of items 2. When registering (e.g. when or after purchasing item 2), users may provide personal information to be inserted into the information in database 17, and which they authorize to communicate and/or make available to other users. At the user's discretion, information to be shared with other users may also include personal data, such as name and surname and/or e-mail addresses, telephone numbers, etc., if the user wishes to pursue the relay communication non-anonymously. In which case, despite revealing his or her identity, the user is assured an interpersonal communication-relationship solely with other registered users.

Users may, for example, form part of an “internet community”, such as “facebook”, “myspace”, etc., which is accessed by registering.

System 1 operates as follows.

When the wearer of personal item 2 encounters a person arousing interest or liking in a predetermined area or environment covered by network 15, this feeling is manifested in a variation in physical, physiological, or body parameters, e.g. increased heartbeat, which is detected by sensor 6, and chip 10 accordingly transmits a unique-code identification signal to server 4.

Server 4 checks and selects the registered users in the vicinity of the recognition device 3 sending out the signal and, on receiving the signal and by means of network communication means 5, sends a message to the selected users, i.e. to nodes 16 of network 15 corresponding to the selected users. The message contains at least some of the information associated with the unique code and/or ways of accessing the address associated with the unique code.

Optionally, server 4 compares the information associated with the unique code of the recognition device 3 sending out the signal, with the information provided by other registered users, and only sends the message to users conforming with given compatibility criteria. The information used to make the comparison (e.g. to determine user compatibility) may also include a genetic profile and/or DNA (or part of it).

The server-selected user/s receive the message informing them of the feeling and interest aroused by them in a nearby registered user, so the signal-sending user may directly approach the user of interest, who, being informed by message of the feeling aroused by them, is better disposed and more confident. The encounter between the two users is thus made easier, also because they are both registered users. The selected users may also, if they wish, send the communication-activating user, via server 4 to maintain their anonymity, a message to initiate relay, e.g. internet, communication.

System 1 can also be operated over a known satellite system (not shown) which informs server 4 of the location of registered users. When item 2 equipped with recognition device 3 transmits the unique-code identification signal to server 4, the server, by means of the satellite system, selects the registered users, to send the message to, within a predetermined distance from recognition device 3.

Obviously, as opposed to a WSN, network 15 may be any other type of wireless communication network, e.g. a cellular telephone network.

System 1 according to the invention may also be used for other than the application described, e.g. for promotional, advertising, commercial, service and/or public service purposes.

For example, when the wearer of personal item 2 enters a predetermined area or environment, e.g. a shop or shopping centre, covered by network 15, and is aroused by an article of particular interest, the resulting variation in physical, physiological or body parameters is detected by sensor 6 and activates communication with server 4. In which case, on receiving the signal from communication device 8 associated with the unique code of item 2, server 4 sends the wearer of item 2 a message, e.g. an advertising or commercial or service message, concerning the product that has aroused the user's interest.

System 1 can be calibrated to distinguish a pathological variation in the parameters detected by sensor 6. If a variation in the parameter over and above a predetermined critical threshold is detected, communication device 8 sends a danger signal, again associated with the unique code of item 2, to server 4 who sends a message, indicating the medical problem of the owner of item 2, to a medical practitioner or person specified when registering.

Clearly, changes may be made to the system as described and illustrated herein without, however, departing from the scope of the invention as defined in the accompanying Claims.

For example, personal item 2 may be connected—preferably by wireless communication device 8 (of any known type, such as Bluetooth, radiofrequency, etc.)—to another portable device 18, in particular a portable communication device, such as a cellular telephone or palm-top. In which case, communication device 8 connected to sensor 6 communicates with server 4 via device 18, as opposed to directly.

The system according to the invention may obviously also be used for applications other than those described above by way of example, especially if item 2 is connected to a portable communication device 18 (e.g. a cellular telephone, palm-top, satellite navigation system, etc.).

For example, system 1 may be used as a driver safety system, to prevent drivers from falling asleep at the wheel or driving in an unfit condition.

When sensor 6 detects a parameter variation that, on the basis of memorized data (possibly calibrated on the wearer of item 2), it interprets as a danger situation, communication device 8 sends out a danger message and/or activates appropriate alarms.

More specifically, the detected parameter may represent the onset of drowsiness, e.g. slow heartbeat or any other parameter originating in drowsiness; or may represent an unfit condition of the driver due to alcohol or drug abuse, e.g. again heartbeat, or a perspiration property indicating alcohol level or the presence of drugs; or may represent any other unfit state (determined optionally by comparing detected data with the user's/driver's personal reference data stored in microcontroller 7).

On detecting the danger-level variation in parameters, communication device 8 sends out a danger signal to activate an acoustic alarm fitted, for example, to item 2 (e.g. integrated in signalling means 11) or to device 18 or to the driver's vehicle. At the same time, communication device 8 communicates with server 4, who sends a message to an operator and/or person specified when registering, indicating the driver's condition, as well as a warning message directly to the driver, e.g. again by means of device 18, advising the driver to stop. This application may be implemented to advantage using a car steering wheel, in which sensors are inserted, as a personal item.

Another application is assisting hikers, runners, cyclists, motorcyclists, etc. in difficulty, by server 4 sending a danger signal, upon detection of abnormal parameters, in the form, for example, of a warning message to a medical practitioner and/or specified contact and/or directly to the user.

1. An interpersonal communication system comprising a portable personal item, such as an item of clothing, a clothing accessory or a portable device or any other object in contact with a person, fitted with a recognition device which is associated with a unique code and comprises at least one sensor for detecting a parameter of the person wearing the item, and a communication device for transmitting to a server, upon the sensor detecting a variation in the parameter, an identification signal identifying the unique code; and network communication means which, upon the server receiving the signal, send a message to one or more users selected by the server.

2. A system as claimed in claim 1, and comprising a wireless communication network connected to the server, in particular a wireless sensor network (WSN) comprising a number of distributed nodes defined by respective recognition devices, and/or a cellular telephone network.

3. A system as claimed in claim 2, wherein the communication device is activated when the item with the recognition device is in a predetermined area or environment covered by the network.

4. A system as claimed in claim 1, wherein the recognition device comprises one or more sensors, a microcontroller, and a wireless communication device.

5. A system as claimed in claim 1, wherein the sensor is associated with a radiofrequency identification RFID chip containing the unique code and which communicates with the server.

6. A system as claimed in claim 1, and comprising a database of registered users; and wherein, upon the server receiving the signal, the network communication means send a message to one or more registered users selected by the server in a predetermined area or environment.

7. A system as claimed in claim 6, wherein the predetermined area or environment is defined in the vicinity of the recognition device sending the signal.

8. A system as claimed in claim 1, wherein the unique code is combined with information relating to the owner of the item and/or with a relay communication address, such as an e-mail box, an internet community personal page, a telephone number, etc.

9. A system as claimed in claim 8, wherein the message sent to users contains at least some of the information combined with the unique code and/or ways of accessing the address combined with the unique code.

10. A system as claimed in claim 1, wherein the item comprises one or more sensors for detecting one or more physical parameters selected from a group comprising: heartbeat, body temperature, perspiration.

11. A system as claimed in claim 1, wherein the sensor is fitted to the item so as to contact the skin of the person wearing the item.

12. A system as claimed in claim 1, wherein the item is an item of clothing, or a clothing accessory, or a portable device, or any other personal item worn in contact with the skin, or part of a complex device, such as a car, a vehicle, etc., that is normally used in contact with the user's skin, such as a vehicle steering wheel, a bicycle or motorcycle handlebar, etc.

13. A system as claimed in claim 1, wherein the item comprises or is connected to signalling means, e.g. vibratory, acoustic, or visual, connected to the sensor to emit a warning signal upon the sensor detecting a variation in the physical parameter.

14. A system as claimed in claim 1, wherein the server sends a message, e.g. an advertising or commercial or service message, to the wearer of the personal item.

15. A system as claimed in claim 1, wherein the sensor detects parameters indicating the onset of drowsiness and/or an altered state due to alcohol or drug abuse; and if the sensor detects a parameter variation that, on the basis of memorized data possibly calibrated on the wearer of the item, it interprets as a danger situation, the communication device sends out a danger message and/or activates appropriate alarms.

16. A system as claimed in claim 1, wherein the item is connected to a portable communication device, such as a cellular telephone, a palm-top, a satellite navigation system, etc.
